(19) United States
(12) Patent Application Publication
(10) Pub. No.: US 2020/0116869 A1
(43) Pub. Date: Apr. 16, 2020

(54) OPTIMAL PERFORMANCE OF GLOBAL NAVIGATION SATELLITE SYSTEM IN NETWORK AIDED EMERGENCY SCENARIOS

(71) Applicant: Samsung Electronics Co., Ltd., Gyeonggi-do (KR)

(72) Inventor: Gary LENNEN, Cupertino, CA (US)

(21) Appl. No.: 16/232,781

(22) Filed: Dec. 26, 2018

Related U.S. Application Data
(60) Provisional application No. 62/745,033, filed on Oct. 12, 2018.

(51) Int. Cl. G01S 19/32; G01S 19/34; G01S 19/24

(52) U.S. Cl. CPC G01S 19/32; G01S 19/246; G01S 19/34

(57) ABSTRACT

A method, electronic device, and system are herein disclosed. The method includes loading a plurality of available satellite signal carriers, generating a hypothesis for each of the plurality of available satellite signal carriers, combining the plurality of available satellite signal carriers into a number of signal combinations based on the created hypotheses, and determining whether a satellite signal is detected with one of the number of signal combinations.

### PRIORITY

This application is based on and claims priority under 35 U.S.C. § 119(e) to a U.S. Provisional Patent Application filed on Oct. 12, 2018 in the United States Patent and Trademark Office and assigned Ser. No. 62/745,033, the entire contents of which are incorporated herein by reference.

### FIELD

The present disclosure relates generally to a method and system for optimizing performance of a global navigation satellite system (GNSS) in emergency situations.

### BACKGROUND

An important use of global navigation satellite systems (GNSS) in mobile devices is obtaining position fixed when emergency services are requested, such as E-911 in the United States. Standards exist that describe performance tests that GNSS receivers must pass for the E-911 application. Improvements in the availability of a position fix, the speed of generating a position fix, and the quality of the position fix in emergency services when utilized by a user of the mobile device are desired.

### SUMMARY

According to one embodiment, a method is provided. The method includes loading a plurality of available satellite signal carriers, generating a hypothesis for each of the plurality of available satellite signal carriers, combining the plurality of available satellite signal carriers into a number of signal combinations based on the created hypotheses, and determining whether a satellite signal is detected with one of the number of signal combinations.

According to one embodiment, an electronic device is provided. The electronic device includes a global navigation satellite system (GNSS) receiver, a processor, and a non-transitory computer readable storage medium storing instructions that, when executed, cause the processor to load a plurality of available satellite signal carriers, generate a hypothesis for each of the plurality of available satellite signal carriers, combine the plurality of available satellite signal carriers into a number of signal combinations based on the created hypotheses, and determine whether a satellite signal is detected with one of the number of signal combinations.

According to one embodiment, a method for determining a location of a device in a GNSS is provided. The method includes selecting a first device location determining process based on a power consumption of the first device location determining process on the device, attempting to locate the device with the selected first device location determining process, and selecting a second device location determining process when the attempting with the first device location determining process fails. The second device location determining process has a higher power consumption than the power consumption of the first device location determining process.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a graph of correlations, according to an embodiment;

FIGS. 2 and 3 are graphs of frequency bins, according to an embodiment;

FIG. 4 is a graph of loss versus offset, according to an embodiment;

FIG. 5 is a flowchart of a method of aiding emergency scenarios, according to an embodiment;

FIGS. 6, 7, 8, 9, 10, 11, 12, 13 and 14 are graphs showing signal combinations, according to an embodiment;

FIGS. 15, 16 and 17 are graphs of signal search space, according to an embodiment;

FIG. 18 is a flowchart of a method for device location with battery life consideration, according to an embodiment; and

FIG. 19 is a block diagram of an electronic device in a network environment, according to one embodiment.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

The electronic device according to one embodiment may be one of various types of electronic devices. The electronic devices may include, for example, a portable communication device (e.g., a smart phone), a computer, a portable multimedia device, a portable medical device, a camera, a wearable device, or a home appliance. According to one embodiment of the disclosure, an electronic device is not limited to those described above.

The terms used in the present disclosure are not intended to limit the present disclosure but are intended to include various changes, equivalents, or replacements for a corresponding embodiment. With regard to the descriptions of the accompanying drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1^{st},” “2nd,” “first,” and “second” may be used to distinguish a corresponding component from another component, but are not intended to limit the components in other aspects (e.g., importance or order). It is intended that if an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC).

Standards exist that describe performance tests that GNSS receivers must pass for the E-911 application. Mobile Station A (MSA) test and Mobile Station B (MSB) test are two examples of such standards, including elements of GNSS sensitivity and position accuracy. MSA test is the part of cell phone standards testing where the GNSS receiver makes measurements then sends them to the network and the network subsequently computes user position using those measurements. In the MSA test, the GNSS receiver gets aiding information from the network but not a position estimate. The receiver generates measurements that are sent back to the network and the network computes the position fix. MSB test is the part of cellphone standards testing where the GNSS receiver makes measurements and computes user position then sends the position to the network. In the MSB test, the GNSS receiver gets aiding information from the network including position estimate. The receiver generates a position fix that is sent back to the network.

The state of the art GNSS receiver commonly meets minimum E-911 test standards, and the technology disclosed herein greatly surpasses the minimum requirements by intelligently integrating modernized signals. The technology focuses on global positioning satellite (GPS) signals, but is equally applicable to other GNSS systems. The technology intelligently combines GPS signals L1 C/A, L1-C, L5-I and L5-Q, and the focus is on signals transmitted by individual satellites as GNSS receivers currently do not optimize signals from each satellite for emergency scenarios.

There are two main phases of receiver operation in MSA and MSB. The first is acquisition, in which the fine aiding uncertainty space is searched for the presence of signals. The second is tracking, in which the found signal energy is further processed to produce range and range rate measurements.

There are two basic types of situations for aiding emergency scenarios with GNSS. The first is simulated testing, which usually has a known relationship with the received signal power. Generally, there is no multipath except in MSA/MSB multipath testing and even then, the multipath is a fixed delay and does not cause cross fading. In general, there is no multipath fading but frequency diversity still provides an important advantage in terms of interference performance, where, for example, L1 may be interfered with but L5 is not.

The second situation is real world operation. In real world operation, the received power is not fixed for each satellite and may vary substantially.

In both situations, the relative transmit power between signals with the same carrier frequency is expected to be relatively fixed. For example, in L1, GPS C/A and L1-C_{D,P} signals have a known transmit power relationship. In L5, for example, L5-I and L5-Q signals have a known transmit power relationship. Also, in the real world situation, signals with the same carrier frequency are expected to exhibit the same flat fade behavior.

Table 1 shows data regarding GPS transmit power.

TABLE 1

| | | | Transmit | | | Secondary |
|---|---|---|---|---|---|---|
| | Transmit | Transmit | power w.r.t. | Maximum | Data channel | code |
| | power | power pilot | L1 C/A | Coherent | bit interval | length |
| Signal | (dBW) | only (dBW) | (dBs) | (msecs) | (msecs) | (bits) |
| L1 C/A | −158.50 | N/A | 0 | 20 | N/A | N/A |
| L1-C | −157.00 | −163.00/−158.25 | +0.25 | ≈100 | 10 | 1800 bit |
| | | | | | | shortened |
| | | | | | | LSFR, |
| | | | | | | unique per |
| | | | | | | SV |
| L5 | −154.90 | −157.9 | +0.6/+0.6 | ≈100 | 10 | 20 bit |
| | | | | | | Neuman- |
| | | | | | | Hofman |
| | | | | | | code, 1 |
| | | | | | | msec/bit |
| | | | | | | (191) |
| L2-C | −161.5* | −164.5 | −6/−6 | ≈100 | 20 | |

L1 C/A transmit power is 0.25 dB weaker than L1-C_{P} according to the interface control document (ICD). Assuming the L1 C/A data stream is unknown, this limits coherent integration to 20 msecs. There is no inherent limit on coherent integration time when the L1-C_{P} pilot secondary code is known. Thus, the systems can measure and store the actual transmit power difference between the L1 C/A signal carrier and the L1-C_{P} signal carrier and use the difference to adjust the ratio term. However, the L1-C_{D} data channel transmit power may not be sufficiently strong to function as a candidate for combination (e.g., limited to 10 msecs coherent integration and it is 4.75 dB weaker in terms of transmit power). The L1-C pilot signal and the L1-C_{D} data may not need combining.

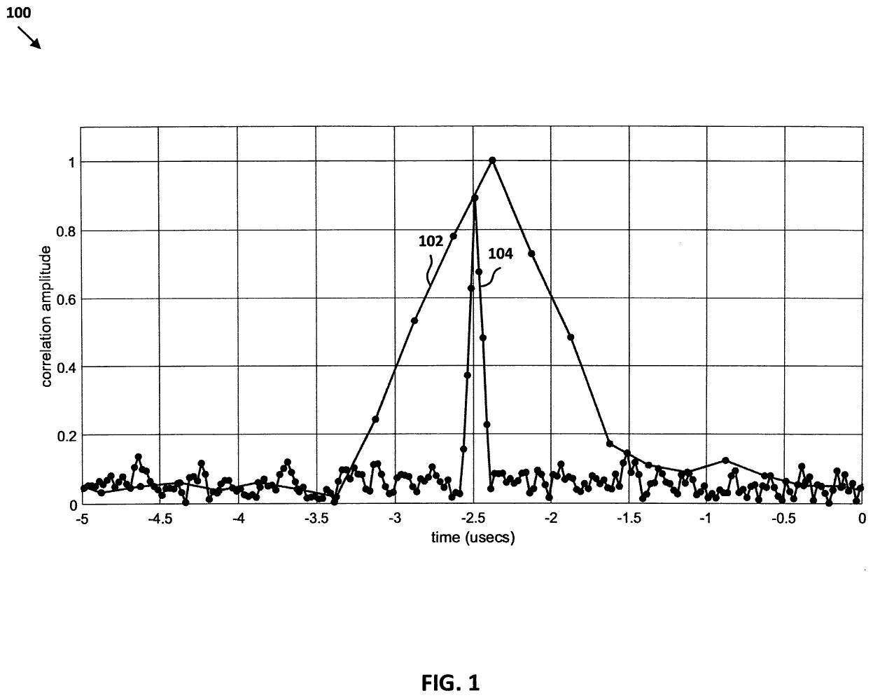

FIG. 1 is a graph 100 showing correlations, according to an embodiment. In graph 100, line 102 represents L1 C/A and line 104 represents L5, and graph 100 shows an example of correlations between these signals. The signals are created independently, having different characteristic correlation width. Typically, the peak of 102 and 104 would be compared with a threshold. As disclosed herein, the peaks are combined in a coherent and non-coherent way to improve signal to noise ratio (SNR) before the combined peak is compared to the threshold. In general, different thresholds are required for each signal and its integration time, and the thresholds are precomputed via simulations or mathematical formulas. Graph 100 shows an example of an I correlation. An equivalent Q correlation is also created, and both I and Q are present in the later combination equations. This situation can also lead to significant fading of L1 vs L5 and vice versa (L1 and L5 are sufficiently separated in transmit frequency such that they can be subjected to significantly different signal fading with respect to each other). Thus, L1 and L5 signals are combined but may also be looked at separately post correlation.

Cross frequency signal checks between satellite signal carriers, such as between L1 and L5, can have significant impact during emergency scenario aiding. The check process covers a host of issues created by bad or flawed measurements, including interference, cross correlation and other mechanisms that can cause false or significantly skewed signal detection. Limits may be placed on the differences of detected ranges and detected range rates. In simulated situations, the difference limit for ranges and range rates may be small as significant multipath is not expected. In real world situations, the difference limit for ranges and range rates is expanded to include expected multipath induced range delay and carrier frequency offset.

Uncertainties occur from acquisition and tracking phases. For example, time uncertainty after application of network fine time and range uncertainty from precise network aiding may be ±20 μseconds and ±6000 meters, respectively. Multipath induced range uncertainty may be 0-1 km. Frequency uncertainty after application of network fine frequency may be about 0.1 ppm and range rate uncertainty from precise network aiding may be about ±158 Hz in L1 and about ±118 Hz in L5. Multipath induced range rate uncertainties may include maximum user velocity about ±30 ms⁻¹ or about ±67 mph, Doppler uncertainty Δf=(Δv fc)/c, about ±158 Hz in L1 and about ±118 Hz in L5 (Doppler uncertainty in Hz based on user velocity (Δv) and speed of light (c)). The total range uncertainty may be about 6500 meters, and the total range rate uncertainty may be about 316 Hz in L1 and about 236 Hz in L5. Example acquisition parameters with ¼ chip code delay bins include maximum carrier-to-noise density ratio (CNO) loss at about 0.32 dB at ⅛ chip offset. With 15 Hz carrier frequency bins (20 msec coherent), the maximum CNO loss is about 0.32 dB at 7.5 Hz carrier frequency offset.

The L5-I satellite signal and the L5-Q satellite signal are transmitted with identical power. Assuming the L5-I data stream is unknown, the coherent integration is thereby limited to 10 msecs. As the L5-Q pilot secondary code is known, there is no inherent limit on the coherent integration time. Thus, the L5-I signal that is coherently integrated to 10 msecs can be combined with the L5-Q signal with various coherent integration times. This results in a design trade-off between SNR gain achieved, the required number of hypothesis to be created, and degradation due to the receiver clock dynamics and user motion.

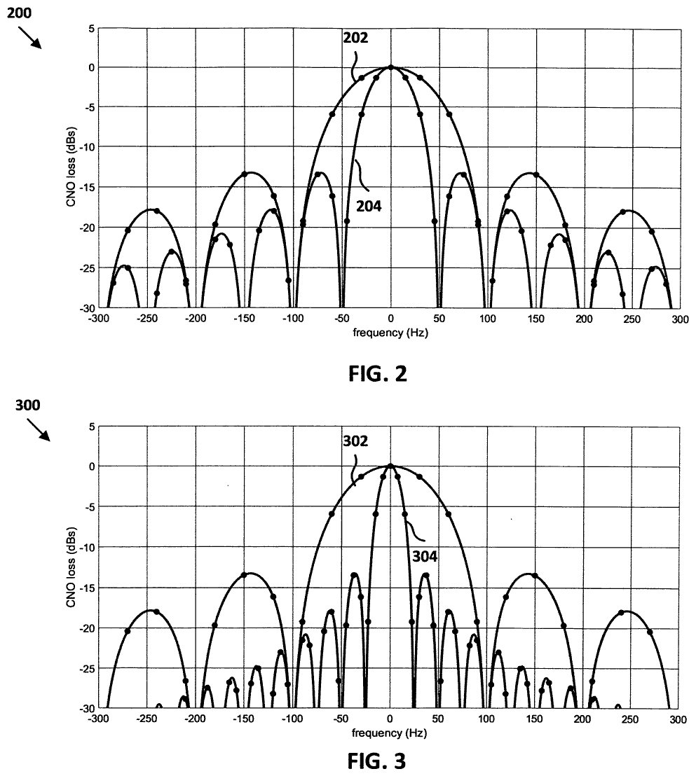

FIG. 2 is a graph 200 showing frequency bins, according to an embodiment. FIG. 3 is a graph 300 showing frequency bins, according to an embodiment. Increasing the coherent integration time requires an increased number of frequency bins. As shown in graph 200, the frequency bins 202 associated with 10 msec integration period are fewer than the frequency bins 204 associated with 20 msec integration period. Furthermore, as shown in graph 300, the frequency bins 302 associated with 10 msec integration period are fewer than the frequency bins 304 associated with 40 msec integration period. 100 msecs integration may see about 1 dB degradation due to the crystal oscillator/temperature controlled crystal oscillator drift by itself. The L5 signal wavelength is about 0.25 meters. Thus, if the user moves 1 meter to or from a satellite in 1 second, that is 4 L5 signal wavelengths. In 100 msecs integration, that will result in 0.4 wavelengths or 2.5 Hz, with a loss of about 0.9 dB. For 20 msecs integration, the loss is about 0.04 dB. For 40 msecs integration, the loss is about 0.14 dB. The transmit power between L5-I and L5-Q is likely to remain close to 50/50.

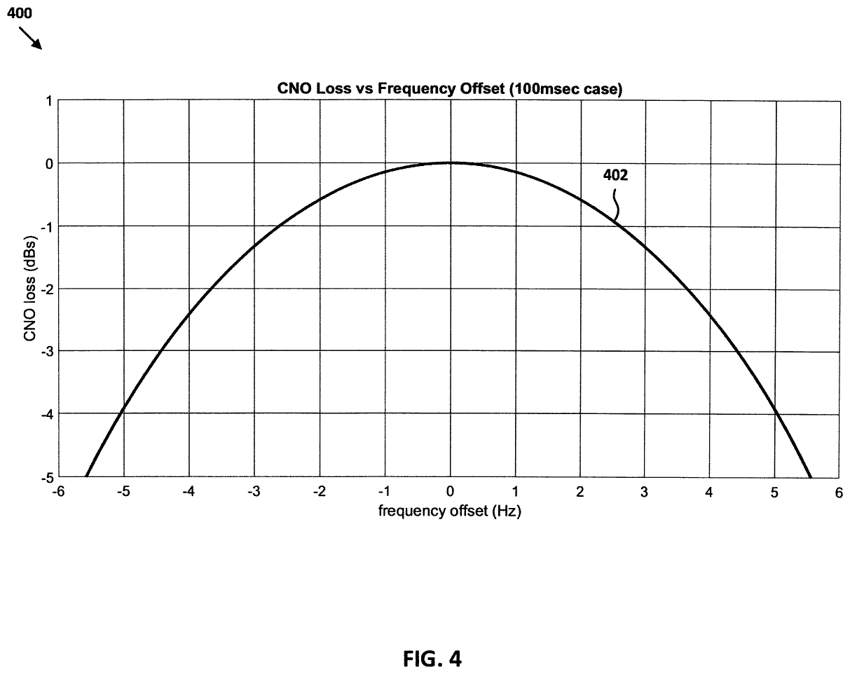

FIG. 4 is a graph 400 of loss versus offset, according to an embodiment. In graph 400, line 402 tracks the CNO loss versus the frequency offset in a 100 msec case. The CNO loss is closest to 0 at a 0 frequency offset, and the dispersion is nearly uniform across frequency offsets from about −5.5 Hz to 5.5 Hz

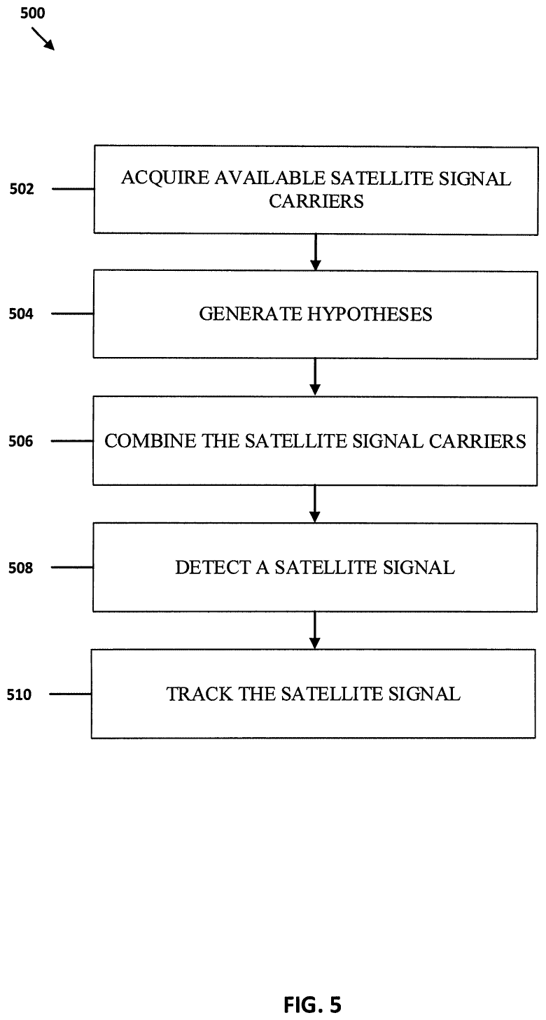

FIG. 5 is a flowchart 500 for a method of aiding emergency scenarios, according to an embodiment. At 502, available satellite signal carriers are acquired. The term “satellite signal carriers” may be used interchangeably with the term “satellite signals.” Available satellite signals may be loaded on a per satellite basis, and an acquisition engine may be initialized based on individual signal availability. This information may be acquired via the network aiding or previously stored in the receiver via Almanac/Ephemeris data decoding. Satellite states include: 1=satellite vehicle (SV) transmit on L1 C/A ok, 0=SV transmit on L1 C/A not ok. For all signals, such as L1 C/A, L1-C_{P} and L5-Q, for example, an SV may not be ok (e.g., state 0) because it is not transmitting or not transmitting a healthy signal, such as an L5-Q where all GPS satellites are not yet transmitting L5-Q as an official “healthy” signal due to its pre-operational condition, but it may be used by receivers because there is nothing wrong with the signal (e.g., L5-Q is officially unhealthy via the satellite's data stream state, but may be good to be used). The selection of the mode, or particularly, whether to use a 100 msec mode may be dependent on user dynamics (e.g., measured via MEMS sensors).

At 504, hypotheses are generated. Table 2 shows maximum L1 and L5 acquisition hypothesis.

TABLE 2

| | | | Search | | | |
|---|---|---|---|---|---|---|
| | Coherent | Data type | parameters | Correlation | Carrier | |
| Signal | period | D = data | (μsecs, | delay | frequency | Total NCS |
| Type | (msecs) | P = pilot | frequency Hz) | hypothesis | hypothesis | hypothesis |
| L1 C/A | 20 | D | ¼, 15 | 178 | 43 | 7654 |
| L5-Q | 20 | P | 1/40, 15 | 1775 | 32 | 56800 |
| L5-Q | 100 | P | 1/40, 3 | 1775 | 158 | 280450 |
| L5-I | 10 | D | 1/40, 30 | 1775 | 16 | 28400 |
| L1-C_{P} | 20 | P | ¼, 15 | 178 | 43 | 7654 |
| L1-C_{P} | 100 | P | ¼, 3 | 178 | 211 | 37558 |
| Total | | | | | | 418516 |

The total non-coherent summation (NCS) hypothesis utilizes about 55 times more memory than L1 C/A signal only. Additional memory is required for renewing every second process. 20 msec coherent integration may be utilized if significant unknown frequency drift is present. Coherent summation means integrating I and Q over time, while NCS refers to integrating the magnitude of the signal over time, where the magnitude equals \sqrt{I²+Q²}.

TABLE 3

| | | SNR Gain |
|---|---|---|
| | | (dBs) |
| | | w.r.t. |
| Row number | Signal type | L1 C/A 20 |
| 1 | L1 C/A 20 | 0 |
| 2 | L1-C_{P} 20 | +0.25 |
| 3 | L1-C_{D} 10 | −4.75 − 1.5 = −6 |
| 4 | L5-I 10 | +0.6 − 1.5 = 2.1 |
| 5 | L5-Q 20 | +0.6 |
| 6 | L5-Q 100 | 0.6 + 3.5 = 4.1 |
| 7 | L1-C_{P} 100 | 0.25 + 3.5 = 3.75 |

Table 3 shows the SNR available from non-combined signals. The SNR gain is computed with respect to L1 C/A 20. There are two elements of L1 C/A 20: the transmit power as defined in the ICD and the use of a 20 msecs coherent integration period. For example, row 2 shows L1-C_{P} 20. The L1-C ICD shows that the L1-C_{P} component of L1-C is transmitted with 0.25 dB more nominal power than L1 C/A, and the L1-C_{D} component of L1-C is transmitted with 4.5 dB less nominal power than L1 C/A.

The choice of coherent integration period, varies from 10 to 100 msecs in this disclosure, may be dictated by several factors. Shorter coherent periods may be preferable because a given frequency uncertainty range can be covered via fewer frequency hypothesis bins. Longer coherent periods may be preferable because they result in a higher effective SNR. Longer coherent periods may be limited by user dynamics and user clock motion (e.g., coherently integrating for 100 msecs is still practical in the presence of these dynamics). The length of coherent integration may be limited by the existence of unknown data bits. For L1 C/A code, the data bit length is 20 msecs. For L1-C_{D} code, the data bit length is 10 msecs. L1-C_{D} 10 is the signal type in row 3 of Table 2 as the limitation of coherent integration before a data bit transition can occur. The data bit length limit may be overcome by knowing the data bits ahead of time and this is effectively what the pilot signal allows.

When two numbers are shown in the last column of Table 2, the first number represents the transmit power difference with respect to L1 C/A and the second number represents the gain/loss attributed to the coherent period being longer or shorter than 20 msecs. When the coherent period is 20 msecs, the gain from this is 0 dB with respect to L1 C/A 20. The difference in transmit power/coherent period and the resulting SNR with respect to L1 C/A 20 is influential in determining the correct ratio when signals are combined.

Table 4 shows individual hypothesis generation.

TABLE 4

| Signal type | coherent integration | non-coherent | NCS |
|---|---|---|---|
| L1 C/A | I_{L1 C/A 20 msecs} | M_{L1 C/A 20 msecs} | Σ_{1..N}M_{L1 C/A 20 msecs} |
| | Q_{L1 C/A 20 msecs} | | |
| L1-C_{P} | I_{L1-CP 20 msecs} | M_{L1-CP 20 msecs} | Σ_{1..N}M_{L1-CP 20 msecs} |
| | Q_{L1-CP 20 msecs} | | |
| L1-C_{P} | I_{L1-CP 100 msecs} | M_{L1-CP 100 msecs} | Σ_{1..N}M_{L1-CP 100 msecs} |
| | Q_{L1-CP 100 msecs} | | |
| L5-Q | I_{L5-Q 20 msecs} | M_{L5-Q 20 msecs} | Σ_{1..N}M_{L5-Q 20 msecs} |
| | Q_{L5-Q 20 msecs} | | |
| L5-Q | I_{L5-Q 100 msecs} | M_{L5-Q 100 msecs} | Σ_{1..N}M_{L5-Q 100 msecs} |
| | Q_{L5-Q 100 msecs} | | |

In Table 4, M indicates magnitude of a vector, and the signal is the vector that rotates in the IQ plane. An example M generation may be M_{L1 C/A 20 msecs}=√(I_{L1 C/A 20 msecs}²+Q_{L1 C/A 20 msecs}²).

Coherent integration is given by summing I and Q across coherent periods as I_{20 msecs}=Σ_{1 . . . 20} I_{1 msec} and Q_{20 msecs}=Σ_{1 . . . 20} Q_{1 msec}, where 1 msec I and Q correlations are typically output by the receiver matched filter.

The magnitude of the signal after 20 msecs is M_{20 msecs}=√(I_{20 msecs}²+Q_{20 msecs}²) and the equivalently power is P_{20 msecs}=(I_{20 msecs}²+Q_{20 msecs}²) (summing P or M are equivalent). M_{20 msecs} represents one non-coherent sum period, and these are then accumulated over a pre-defined period. Using 1 second as a period, NCS=Σ_{1 . . . N} M_{L1 C/A 20 msecs}, where N=50.

When comparing coherent 10 msecs vs 20 msecs, it is assumed that the overall integration periods, including NCS, are the same. Therefore, 10 msec coherent×100 is 1 second is compared with 20 msec coherent×50. Doubling the coherent integration period improves SNR by 3 dB and adding two NCS values with the same coherent length improves SNR by 1.5 dB. Hence, comparing 50×20 msecs with 100×10 msecs, the 20 msecs adds 3 dB but having half the number of NCS sums subtracts 1.5 dB, leading to a net gain of 1.5 dB.

Signal hypothesis combinations that are possible may be set up, and an integration period mode may be initialized (e.g., 20 msec, 100 msec, etc.). The acquisition engine hypothesis set may be significantly different for each satellite, based on signals available. For limited resource environments, the acquisition engine may be set up for optimal signals first.

At 506, signals are combined. Combining may be performed in the tracking phase. The acquisition phase emphasized signal energy detection. The optimization criteria for the track phase is different, with the optimization criteria being to provide the best quality measurements. Impairment metric performance can be improved by combining correlations from acquisition and tracking phases. In an environment with no multipath (e.g. simulation situations), signals can combine signal energy to improve range and range rate measurements (e.g., combining discriminator outputs with appropriate scaling). Independent L1 and L5 measurements can be taken and sent to the navigation engine (in MSB case), allowing the navigation engine to weight/de-weight the measurements. The earliest arriving signal energy process can be applied to both L1 and L5 signal independently. Earliest arriving signal may not be the best as it may have a marginal CNO. Both L1 and L5 measurements may be sent to the navigation engine to determine the solution. Additional signals may be added during the tracking, such as L2c, that have little value for acquisition but provide beneficial diversity in the tracking.

Signals at one frequency can be used to maintain track at another frequency (cross frequency aiding with frequency scaling). For example, L5-Q can be tracked, the range and range rate can be measured, and those values can be fed to the L1-CIA for the purpose of aiding the track and measurement process. This allows for narrowing of the L1-C/A automatic frequency control (AFC), phase lock loop (PLL) in these cases such that the tracking is more sensitive than the regular threshold. Example thresholds include a carrier phase lock threshold (26 dB-Hz nominally L1 C/A, down to <20 dB-Hz for L5-Q). This allows measurement of L1 C/A carrier phase in cases where it could not before (and vice versa for L5). Another threshold may include a data decode threshold, which can be improved for L1-C/A and L5-I, via coherent tracking. Another threshold may include a tracking sensitivity threshold (e.g. dBs improvement over short periods where pseudo static phase can be assumed). Signal gaps of L5 can be filled-in to maintain track on L1 and vice versa, including carrier phase maintenance (e.g., syncing the relative carrier phase, then L5 takes over for L1 for short period). Signal loss can be detected on one signal, and then tracking updates from second signal can be immediately swapped. This also permits short time backtrack tracking maintenance. That is, once loop error is detected recent tracking history is filled in via other frequency signal (e.g. allowing 1 second into the past reconstruction of phase and range corrections). This also permits the ability to fix cycle slips on one frequency via the use of signals on the second frequency (applicable to precise point positioning (PPP) and real time kinematic (RTK) techniques).

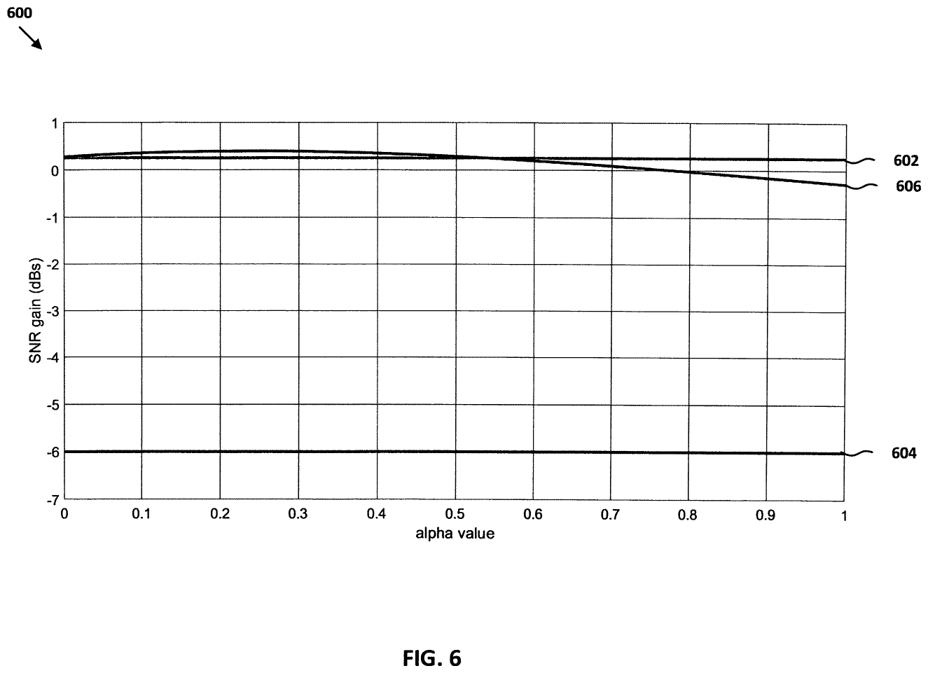

FIGS. 6-12 are graphs of signal combinations, according to an embodiment. In FIG. 6, graph 600 depicts the use of L1-Cp independently at 20 msecs at line 602, a 10 msecs L1-C_{D} signal at line 604, and the signals in combination α (L1-C_{D} 10)+1.0(L1-C_{P} 20) at line 606. Graph 600 shows that this combination results in negligible gain.

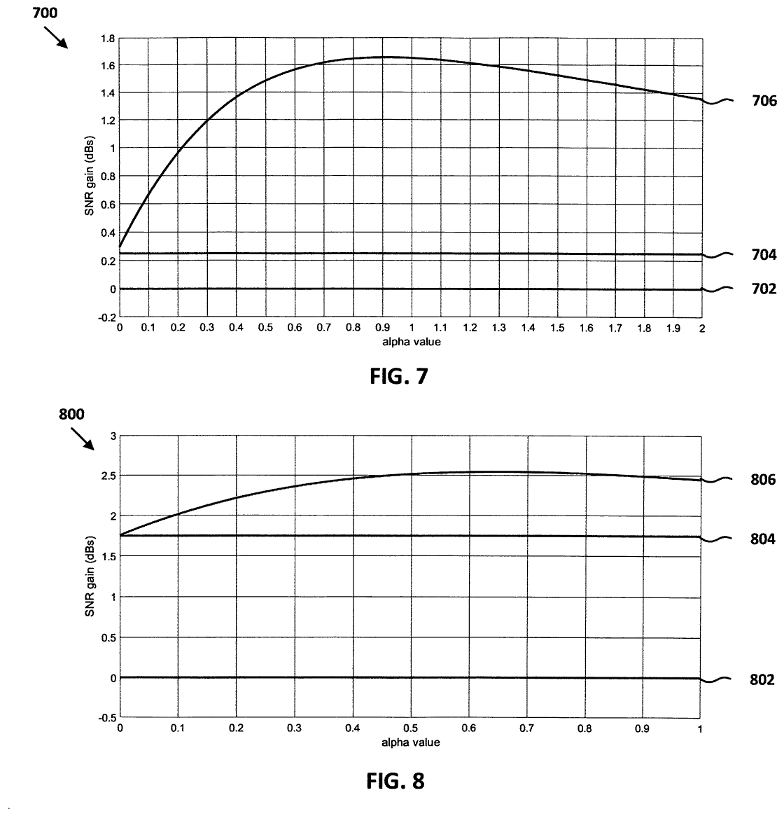

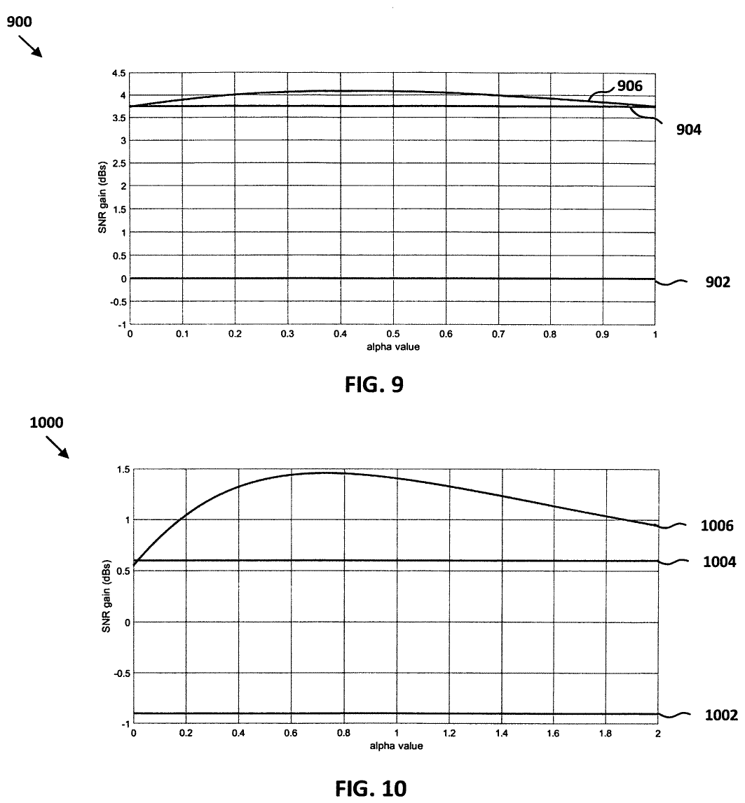

Graph 700 of FIG. 7 shows an L1 C/A signal at 20 msecs 702, an L1-C_{P} signal at 20 msecs 704, and the non-coherent combination α (L1-C_{D} 20)+1.0(L1-C_{P} 20) of the signals at 706. Graph 800 of FIG. 8 shows an L1 C/A signal at 20 msecs 802, an L1-C_{P} signal at 40 msecs 804, and the non-coherent combination α (L1-C_{D} 20)+1.0(L1-C_{P} 40) of the signals at 806. Graph 900 of FIG. 9 shows an L1 C/A signal at 20 msecs 902, an L1-C_{P} signal at 100 msecs 904, and the non-coherent combination α (L1-C_{D} 20)+1.0(L1-C_{P} 100) of the signals at 906.

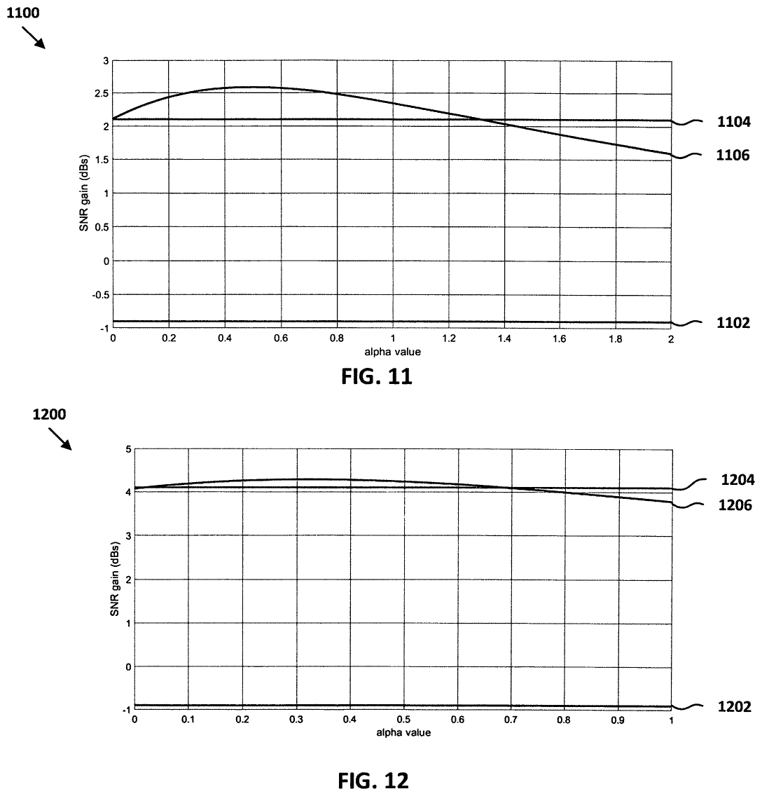

Graph 1000 of FIG. 10 shows an L5-I signal at 10 msecs 1002, an L5-Q signal at 20 msecs 1004, and the non-coherent combination α (L5-I 10)+1.0(L5-Q 20) of the signals at 1006. Graph 1100 of FIG. 11 shows an L5-I signal at 10 msecs 1102, an L5-Q signal at 40 msecs 1104, and the coherent combination α (L5-I 10)+1.0(L5-Q 40) of the signals at 1106. Graph 1200 of FIG. 12 shows an L5-I signal at 10 msecs 1202, an L5-Q signal at 100 msecs 1204, and the coherent combination α (L5-I 10)+1.0(L5-Q 100) of the signals at 1206.

The values of a used in the graphs of FIGS. 6-12 are the power ratio values and may be derived via simulation or mathematically.

Table 5 shows data regarding various signal combinations.

TABLE 5

| | Signal | | SNR Gain | |
|---|---|---|---|---|
| | combi- | | (dBs) | |
| | nation | | w.r.t. | |
| Figure | type | purpose | L1 C/A 20 | MCR |
| 6 | L1-C_{D} 10, | L1-C data + | 0.36 | 0.24 (L1-C_{D} 10) + |
| | L1-C_{P} 20 | pilot | | 1.0 (L1-C_{P} 20) |
| | | combination | | |
| 7 | L1 C/A 20, | L1 C/A + L1-C | 1.63 | 0.94 (L1-C_{D} 10) + |
| | L1-C_{P} 20 | dynamic | | 1.0 (L1-C_{P} 20) |
| | | combination | | |
| 8 | L1 C/A 20, | L1 C/A + L1-C | 2.54 | 0.68 (L1 C/A 20) + |
| | L1-C_{P} 40 | improved | | 1.0 (L1-C_{P} 40) |
| | | sensitivity | | |
| | | combination | | |
| 9 | L1 C/A 20, | L1 C/A + L1-C | 4.09 | 0.42 (L1 C/A 20) + |
| | L1-C_{P} 100 | best sensitivity | | 1.0 (L1-C_{P} 100) |
| | | combination | | |
| 10 | L5-I 10, | L5 dynamic | 1.47 | 0.71 (L5-I 10) + |
| | L5-Q 20 | combination | | 1.0 (L5-Q 20) |
| 11 | L5-I 10, | L5 improved | 2.58 | 0.50 (L5-I 10) + |
| | L5-Q 40 | sensitivity | | 1.0 (L5-Q 40) |
| | | combination | | |
| 12 | L5-I 10, | L5 best | 4.31 | 0.32 (L5-I 10) + |
| | L5-Q 100 | sensitivity | | 1.0 (L5-Q 100) |
| | | combination | | |

In Table 6, the word “dynamic” is used for a combination that is most resistant to user position and clock motion. Longer coherent integration may result in large SNR losses due to these motion elements. The “static” condition may be known via external sensors (e.g. accelerometer). 100 msecs is shown as the maximum coherent integration time but the integration period may be longer for a static user with improved (reduced) user clock noise. If user position dynamics are known (e.g., via an internal measurement unit (IMU)), then this motion can be fed into the coherent integration process (e.g., via projection of user motion onto the vector between the user and a particular satellite). This can then be as good as the static case in terms of allowing longer coherent integration times.

Signals can be combined coherently and non-coherently. As described above, the L1 C/A 20 signal and the L1-C_{P} 20 signal could be non-coherently combined as NCS_{combine}=α(I_{L1 C/A 20}²+Q_{L1 C/A 20}²)+1.0(I_{L1-CP 20}²+Q_{L1-CP 20}²). This results in about 1.6 dB of SNR gain. L1-C_{P} is overlayed by a secondary code of length 1800 bits at 100 bits/second, that is known and can be data stripped to allow longer coherent integration (including 20 msecs). Knowing the data bits also allows the data polarity to be known (e.g., whether the data stream inverted or not). In the NCS equation above, non-coherent combining is used because the L1 C/A data bits are unknown.

If the data bits were known, such as by network aiding or the receiver piecing together data bits from past observation, the L1 C/A 20 signal and L1-C_{P} 20 signal could be coherently combined as COH_{combine}=[(β I_{L1 C/A 20})+I_{L1-CP 20}]²+[(β Q_{L1 C/A 20})+Q_{L1-CP 20}]². β is the MCR that optimizes SNR. β can be ascertained via simulation or mathematical formula.

An important aspect of making the above formula work is that the data polarity of both L1 C/A 20 and L1-C_{P} must be known. If not, the signals will cancel each other out. The data polarity of L1 C/A is commonly extracted via the preamble data bits. Knowing data polarity is not enough and the data bits themselves must also be known. The above coherent combining equation may further be combined with other coherent or non-coherent signal forms.

Coherent combining leads to an improved SNR of about 3.28 dB in the case above versus about 1.6 dB for non-coherent combining. Coherent combining is not possible unless both signals have carrier phase lock with respect to each other. In the case of L1 C/A and L1-C_{P}, they do have a known carrier phase relationship at the receiver, making this possible. Coherently combining signals from different frequencies (e.g., L1 and L5) is limited by the different phase rotation and these signals are impacted during signal flight from transmitter to receiver, usually not known in E-911 type scenarios.

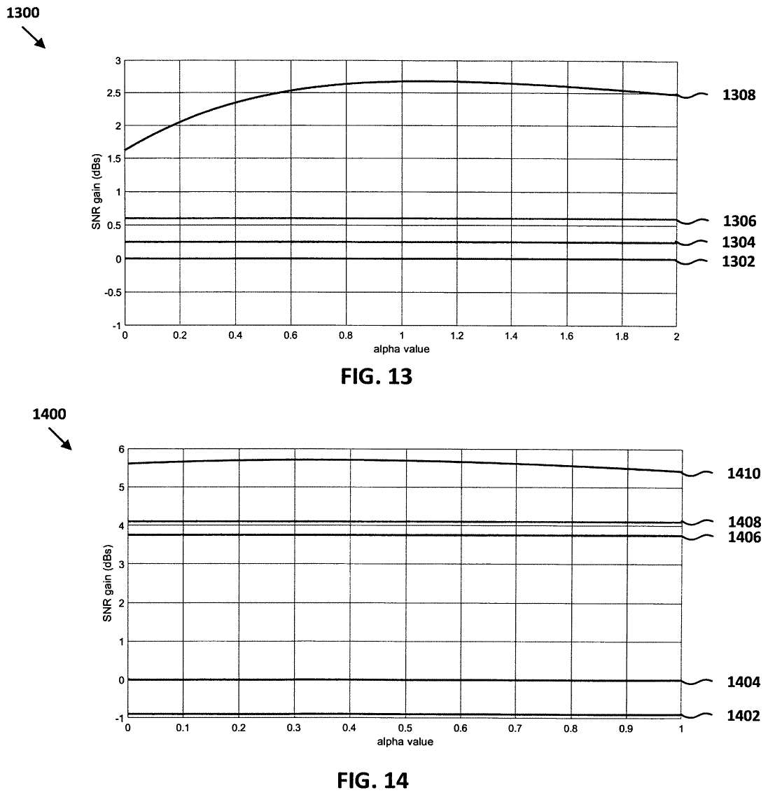

Combinations of more than two signals emanating from the same satellite are possible. FIG. 13 is a graph 1300 showing signal combination of more than two signals, according to an embodiment. In graph 1300, an L1 C/A at 20 msec signal 1302, an L1 C_{P} at 20 msec signal 1304, and an L5-Q at 20 msec signal 1306 are combined by α (L5-Q 20)+0.94(L1 C/A 20)+1.0(L1-C_{P} 20) as shown at line 1308.

FIG. 14 is a graph 1400 showing signal combination of more than two signals, according to an embodiment. In graph 1400, an L5-I at 10 msec signal 1402, an L1 C/A at 20 msec signal 1404, an L1-C_{P} at 100 msec signal 1406 and an L5-Q at 100 msec signal 1408 are combined by α (L5-I 10)+0.42(L1 C/A 20)+1.0(L1-C_{P} 100)+1.08(L5-Q 100) as shown at line 1410.

Table 6 shows data regarding multiple signal combination.

TABLE 6

| | Signal | | SNR Gain | |
|---|---|---|---|---|
| | combi- | | (dBs) | |
| | nation | | w.r.t. | |
| Figure | type | purpose | L1 C/A 20 | MCR |
| 13 | L1 C/A 20 | L1/L5 dynamic | 2.68 | 0.94 (L1 C/A 20) + |
| | L1-C_{P} 20 | | | 1.0 (L1-C_{P} 20) + |
| | L5-Q 20 | | | 1.09 (L5-Q 20) |
| 14 | L1 C/A 20 | L1/L5 best | 5.71 | 0.34 (L5-I 10) + |
| | L1-C_{P} 100 | sensitivity | | 0.42(L1 C/A 20) + |
| | L5-Q 100 | | | 1.0(L1-C_{P} 100) + |
| | L5-I 10 | | | 1.08(L5-Q 100) |

At 508, signals are detected. During acquisition phase hypothesis generation, an I and Q hypothesis may be generated for L1 C/A, L1-C_{P} and L5-Q for an integration period, and early termination may be checked for individual and signal combinations. There may be six total signal combinations, L1 C/A, L1-CP, L5-Q, L1 C/A+L1-C_{P}, L1 C/A+L5-Q, L1-C_{P}+L5-Q. A threshold may be established for detection of early termination and may be based on a low probability of false alarm (e.g., probability of detection is fixed when a probability of false alarm is established).

In some examples, if no signal is detected after checking the individual signals and combinations, additional hypothesis may be generated. For example, every second, a new set of extended integration (EI) combination hypothesis are generated. As an example, each EI combination may complete after a given time period (e.g., 8 seconds). During the first second of the time period, a first EI may be run, and while the first EI is running, a second EI may be started, such as during the 2nd second of the time period. Thus, in this example, after 8 seconds, 8 EIs are running. This process provides protection against CNO variation during the EI process, and alternative time period may be utilized depending on the parameters.

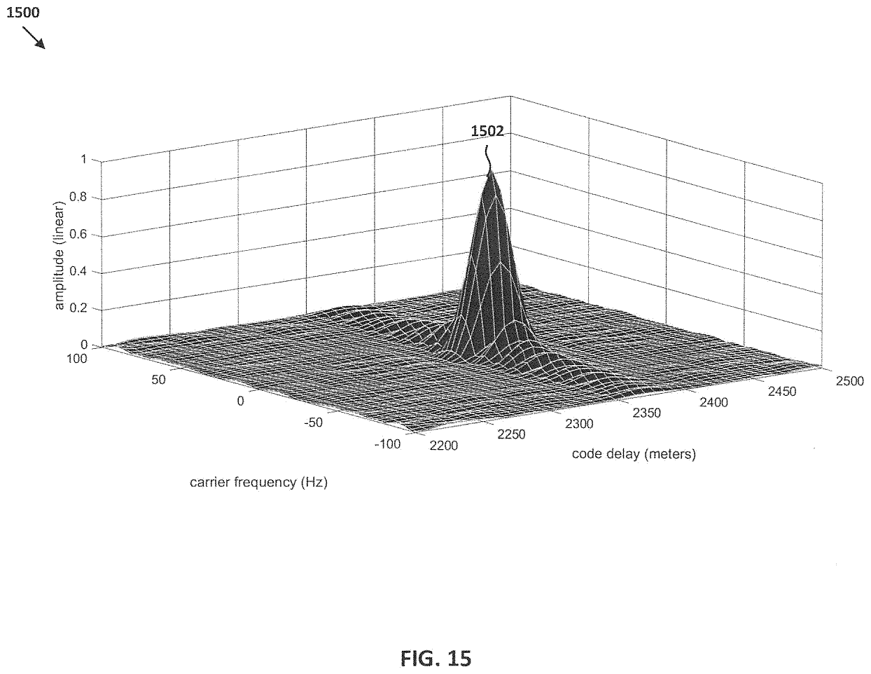

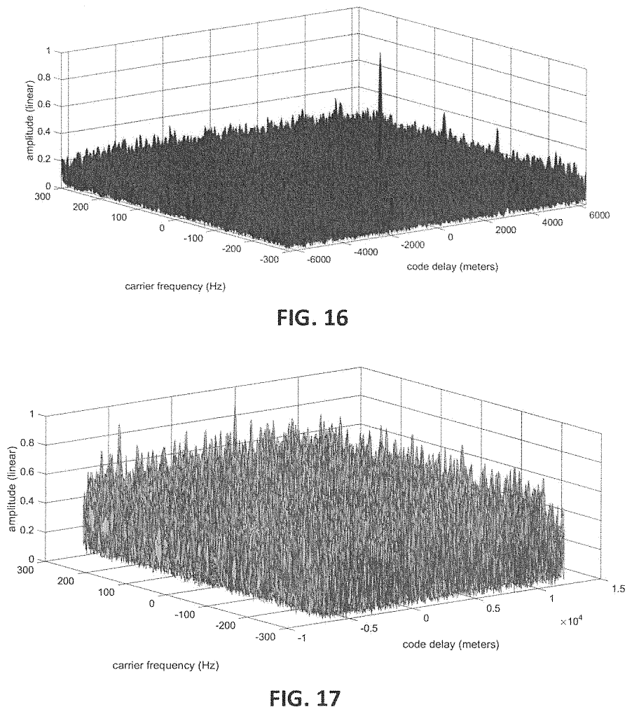

Before testing a combined hypothesis, peaks of signals may be combined by finding the maximum power of each signal and combining those. FIG. 15 is a graph 1500 showing a power peak, according to an embodiment. In graph 1500, the entire search space of the L5-Q signal is depicted, with the power peak 1502. FIG. 15 shows a high CNO signal where the signal is prominent with respect to the background noise. As the CNO drops in challenging environments, the signal's power within the two dimensional search space becomes much less obvious. FIGS. 16 and 17 are graphs of search spaces, according to an embodiment. In FIGS. 16 and 17, it is shown that it can be difficult to identify a power peak within the signal's own search space.

At 510, the signal is tracked. If a signal combination is detected, the combination may be put into the track, and the track may include up to the six combinations. Furthermore, multiple tracks may be set up for multiple signals/signal combinations. Combining tracking in the carrier AFC improves sensitivity, as the receiver sensitivity is usually dependent on the AFC only such that combining the signals in code tracking makes less sense. The tracks may be checked against impairment metrics and, if a false track is detected, it is cross checked against other signals from the SV and any other false tracks are abandoned. In one example of a cross-check, if L1 C/A track indicates cross correlation, then it is checked against carrier frequency and code phase. If the L1-C_{P} track is close in frequency/phase, it is likely not a cross correlation track (given the substantially different cross correlation characteristics of L1 C/A versus L1-C_{P}). If a false track is not detected, then the range and range rate measurements may be formed. In the MSA case, measurements may be sent back to the network.

Further considerations may be made for the battery life of the device. As the processes described above utilize many resources, desired performance would include not consuming all the battery life or adjusting the performance based on a remaining battery life. For example, when an emergency position detection is required to be completed within 20 seconds (e.g., 10 second acquisition and 10 second track/measurement formation), using all signals may consume about 20% of the battery life during the 20 second cycle. However, using fewer signals, such as L1 C/A and L1-C (which uses 10% of the battery life during the 20 second cycle) or L1 C/A only (which uses 5% of the battery life during the 20 second cycle), can conserve battery life and/or optimize the position detection. Thus, when the emergency position detection is initiated, the remaining battery life of the electronic device may be determined, and the number of signals or detection process to be executed may be determined based on the remaining battery life.

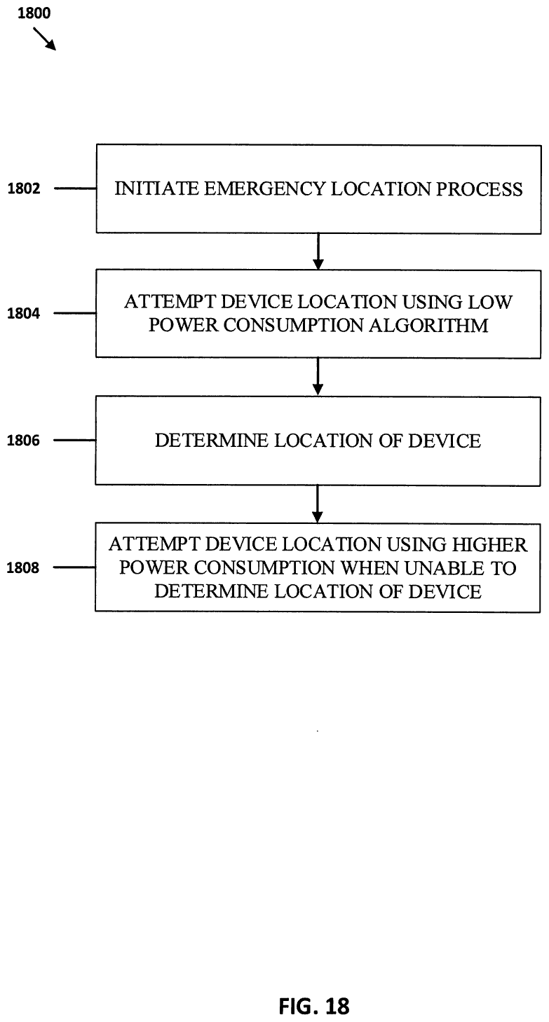

FIG. 18 is a flowchart 1800 of a method for device location with battery life consideration, according to an embodiment. In the method shown in flowchart 1800, location determining processes using the hypothesis generation and signal combination processes above may be utilized in accordance with the power consumption of the device being located. At 1802, an emergency location process is initiated. At 1804, the device location (e.g., locating the device) is attempted using a low power consumption process. In this instance, while higher power consumption processes are available, it may be possible to determine the location of the device using a lower or the lowest power consumption location determining process. At 1806, the location of the device is determined. At 1808, if the device location cannot be determined with the lower power consumption process, the locating of the device is determined using a higher power consumption location determining process.

The method may include a predetermined list of device location determining processes stored on the device that are hierarchically ordered based on their power consumption. For example, an L1 C/A process may be assigned to a low power consumption tier, while a full scenario combining multiple signals may be assigned to a higher power consumption tier. The method in flowchart 1800 may repeat, increasing the tier in the hierarchically ordered list of processes until the location of the device is determined. Combining with multiple signals uses more power than a single signal. This is largely by definition. For example, L1 C/A only requires less power than with L1 C/A+L1-Cₚ because extra power is needed to generate the L1-Cₚ hypothesis. Referring back to FIGS. 6-14, the process in FIG. 6 may be a low power consumption process, while the process at FIG. 14, may be a higher power consumption process. Different applications may impact the order in which the tier is applied. E-911 is one example where substantial battery power is available (or a phone is connected to a charge port). The highest power consumption tier is used to maximize the probability of obtaining satellites measurements leading to a position fix. Alternately, an animal tracking application requiring infrequent position updates may benefit from manual control of tier selected to allow control based on situation.

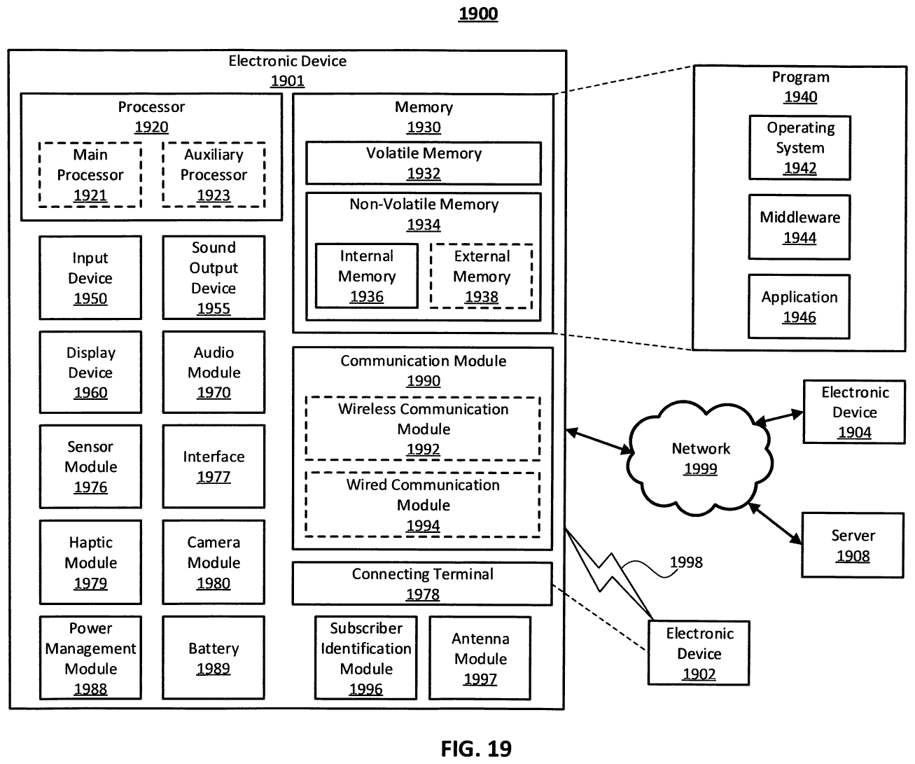

FIG. 19 is a block diagram of an electronic device 1901 in a network environment 1900, according to one embodiment. Referring to FIG. 19, the electronic device 1901 in the network environment 1900 may communicate with an electronic device 1902 via a first network 1998 (e.g., a short-range wireless communication network), or an electronic device 1904 or a server 1908 via a second network 1999 (e.g., a long-range wireless communication network). The electronic device 1901 may communicate with the electronic device 1904 via the server 1908. The electronic device 1901 may include a processor 1920, a memory 1930, an input device 1950, a sound output device 1955, a display device 1960, an audio module 1970, a sensor module 1976, an interface 1977, a haptic module 1979, a camera module 1980, a power management module 1988, a battery 1989, a communication module 1990, a subscriber identification module (SIM) 1996, or an antenna module 1997. In one embodiment, at least one (e.g., the display device 1960 or the camera module 1980) of the components may be omitted from the electronic device 1901, or one or more other components may be added to the electronic device 1901. In one embodiment, some of the components may be implemented as a single integrated circuit (IC). For example, the sensor module 1976 (e.g., a fingerprint sensor, an iris sensor, or an illuminance sensor) may be embedded in the display device 1960 (e.g., a display).

The processor 1920 may execute, for example, software (e.g., a program 1940) to control at least one other component (e.g., a hardware or a software component) of the electronic device 1901 coupled with the processor 1920, and may perform various data processing or computations. As at least part of the data processing or computations, the processor 1920 may load a command or data received from another component (e.g., the sensor module 1976 or the communication module 1990) in volatile memory 1932, process the command or the data stored in the volatile memory 1932, and store resulting data in non-volatile memory 1934. The processor 1920 may include a main processor 1921 (e.g., a central processing unit (CPU) or an application processor (AP)), and an auxiliary processor 1923 (e.g., a graphics processing unit (GPU), an image signal processor (ISP), a sensor hub processor, or a communication processor (CP)) that is operable independently from, or in conjunction with, the main processor 1921. Additionally or alternatively, the auxiliary processor 1923 may be adapted to consume less power than the main processor 1921, or execute a particular function. The auxiliary processor 1923 may be implemented as being separate from, or a part of, the main processor 1921.

The auxiliary processor 1923 may control at least some of the functions or states related to at least one component (e.g., the display device 1960, the sensor module 1976, or the communication module 1990) among the components of the electronic device 1901, instead of the main processor 1921 while the main processor 1921 is in an inactive (e.g., sleep) state, or together with the main processor 1921 while the main processor 1921 is in an active state (e.g., executing an application). According to one embodiment, the auxiliary processor 1923 (e.g., an image signal processor or a communication processor) may be implemented as part of another component (e.g., the camera module 1980 or the communication module 1990) functionally related to the auxiliary processor 1923.

The memory 1930 may store various data used by at least one component (e.g., the processor 1920 or the sensor module 1976) of the electronic device 1901. The various data may include, for example, software (e.g., the program 1940) and input data or output data for a command related thererto. The memory 1930 may include the volatile memory 1932 or the non-volatile memory 1934.

The program 1940 may be stored in the memory 1930 as software, and may include, for example, an operating system (OS) 1942, middleware 1944, or an application 1946.

The input device 1950 may receive a command or data to be used by other component (e.g., the processor 1920) of the electronic device 1901, from the outside (e.g., a user) of the electronic device 1901. The input device 1950 may include, for example, a microphone, a mouse, or a keyboard.

The sound output device 1955 may output sound signals to the outside of the electronic device 1901. The sound output device 1955 may include, for example, a speaker or a receiver. The speaker may be used for general purposes, such as playing multimedia or recording, and the receiver may be used for receiving an incoming call. According to one embodiment, the receiver may be implemented as being separate from, or a part of, the speaker.

The display device 1960 may visually provide information to the outside (e.g., a user) of the electronic device 1901. The display device 1960 may include, for example, a display, a hologram device, or a projector and control circuitry to control a corresponding one of the display, hologram device, and projector. According to one embodiment, the display device 1960 may include touch circuitry adapted to detect a touch, or sensor circuitry (e.g., a pressure sensor) adapted to measure the intensity of force incurred by the touch.

The audio module 1970 may convert a sound into an electrical signal and vice versa. According to one embodiment, the audio module 1970 may obtain the sound via the input device 1950, or output the sound via the sound output device 1955 or a headphone of an external electronic device 1902 directly (e.g., wiredly) or wirelessly coupled with the electronic device 1901.

The sensor module 1976 may detect an operational state (e.g., power or temperature) of the electronic device 1901 or an environmental state (e.g., a state of a user) external to the electronic device 1901, and then generate an electrical signal or data value corresponding to the detected state. The sensor module 1976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1977 may support one or more specified protocols to be used for the electronic device 1901 to be coupled with the external electronic device 1902 directly (e.g., wiredly) or wirelessly. According to one embodiment, the interface 1977 may include, for example, a high definition multimedia interface (HDMI), a universal serial bus (USB) interface, a secure digital (SD) card interface, or an audio interface.

A connecting terminal 1978 may include a connector via which the electronic device 1901 may be physically connected with the external electronic device 1902. According to one embodiment, the connecting terminal 1978 may include, for example, an HDMI connector, a USB connector, an SD card connector, or an audio connector (e.g., a headphone connector).

The haptic module 1979 may convert an electrical signal into a mechanical stimulus (e.g., a vibration or a movement) or an electrical stimulus which may be recognized by a user via tactile sensation or kinesthetic sensation. According to one embodiment, the haptic module 1979 may include, for example, a motor, a piezoelectric element, or an electrical stimulator.

The camera module 1980 may capture a still image or moving images. According to one embodiment, the camera module 1980 may include one or more lenses, image sensors, image signal processors, or flashes.

The power management module 1988 may manage power supplied to the electronic device 1901. The power management module 1988 may be implemented as at least part of, for example, a power management integrated circuit (PMIC).

The battery 1989 may supply power to at least one component of the electronic device 1901. According to one embodiment, the battery 1989 may include, for example, a primary cell which is not rechargeable, a secondary cell which is rechargeable, or a fuel cell.

The communication module 1990 may support establishing a direct (e.g., wired) communication channel or a wireless communication channel between the electronic device 1901 and the external electronic device (e.g., the electronic device 1902, the electronic device 1904, or the server 1908) and performing communication via the established communication channel. The communication module 1990 may include one or more communication processors that are operable independently from the processor 1920 (e.g., the AP) and supports a direct (e.g., wired) communication or a wireless communication. According to one embodiment, the communication module 1990 may include a wireless communication module 1992 (e.g., a cellular communication module, a short-range wireless communication module, or a global navigation satellite system (GNSS) communication module) or a wired communication module 1994 (e.g., a local area network (LAN) communication module or a power line communication (PLC) module). A corresponding one of these communication modules may communicate with the external electronic device via the first network 1998 (e.g., a short-range communication network, such as Bluetooth™, wireless-fidelity (Wi-Fi) direct, or a standard of the Infrared Data Association (IrDA)) or the second network 1999 (e.g, a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1992 may identify and authenticate the electronic device 1901 in a communication network, such as the first network 1998 or the second network 1999, using subscriber information (e.g., international mobile subscriber identity (IMSI)) stored in the subscriber identification module 1996.

The antenna module 1997 may transmit or receive a signal or power to or from the outside (e.g., the external electronic device) of the electronic device 1901. According to one embodiment, the antenna module 1997 may include one or more antennas, and, therefrom, at least one antenna appropriate for a communication scheme used in the communication network, such as the first network 1998 or the second network 1999, may be selected, for example, by the communication module 1990 (e.g., the wireless communication module 1992). The signal or the power may then be transmitted or received between the communication module 1990 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPM), a serial peripheral interface (SPI), or a mobile industry processor interface (MIDI)).

According to one embodiment, commands or data may be transmitted or received between the electronic device 1901 and the external electronic device 1904 via the server 1908 coupled with the second network 1999. Each of the electronic devices 1902 and 1904 may be a device of a same type as, or a different type, from the electronic device 1901. All or some of operations to be executed at the electronic device 1901 may be executed at one or more of the external electronic devices 1902, 1904, or 1908. For example, if the electronic device 1901 should perform a function or a service automatically, or in response to a request from a user or another device, the electronic device 1901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1901. The electronic device 1901 may provide the outcome, with or without further processing of the outcome, as at least part of a reply to the request. To that end, a cloud computing, distributed computing, or client-server computing technology may be used, for example.

One embodiment may be implemented as software (e.g., the program 1940) including one or more instructions that are stored in a storage medium (e.g., internal memory 1936 or external memory 1938) that is readable by a machine (e.g., the electronic device 1901). For example, a processor of the electronic device 1901 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method of aided emergency scenario in a global navigation satellite system (GNSS), comprising:
loading a plurality of available satellite signal carriers;
generating a hypothesis for each of the plurality of available satellite signal carriers;
combining the plurality of available satellite signal carriers into a number of signal combinations based on the created hypotheses; and
determining whether a satellite signal is detected with one of the number of signal combinations.

2. The method of claim 1, further comprising tracking the satellite signal when the satellite signal is determined to be detected.

3. The method of claim 2, wherein tracking the satellite signal further comprises checking the tracked satellite signal against impairment metrics and determining whether the tracked satellite signal is a false track based on the impairment metrics.

4. The method of claim 3, further comprising forming range and range rate measurements when the tracked satellite signal is determined to be true.

5. The method of claim 1, further comprising forming a plurality of extended integration (EI) combination hypotheses when it is determined the satellite signal is not detected.

6. The method of claim 5, wherein the plurality of EI combination hypotheses includes a first EI combination hypothesis and a second EI combination hypothesis, and wherein the second EI combination hypothesis is initiated while the first EI combination hypothesis is running.

7. The method of claim 1, wherein the plurality of available satellite signal carriers are combined into the number of signal combinations based on maximum combining ratio (MCR) weights.

8. An electronic device, comprising:
a global navigation satellite system (GNSS) receiver;
a processor; and
a non-transitory computer readable storage medium storing instructions that, when executed, cause the processor to:
load a plurality of available satellite signal carriers;
generate a hypothesis for each of the plurality of available satellite signal carriers;
combine the plurality of available satellite signal carriers into a number of signal combinations based on the created hypotheses; and
determine whether a satellite signal is detected with one of the number of signal combinations.

9. The electronic device of claim 8, wherein the instructions, when executed, further cause the processor to track the satellite signal when the satellite signal is determined to be detected.

10. The electronic device of claim 9, wherein the instructions, when executed, further cause the processor to check the tracked satellite signal against impairment metrics and determine whether the tracked satellite signal is a false track based on the impairment metrics.

11. The electronic device of claim 10, wherein the instructions, when executed, further cause the processor to form range and range rate measurements when the tracked satellite signal is determined to be true.

12. The electronic device of claim 8, further wherein the instructions, when executed, further cause the processor to form a plurality of extended integration (EI) combination hypotheses when it is determined the satellite signal is not detected.

13. The electronic device of claim 12, wherein the plurality of EI combination hypotheses includes a first EI combination hypothesis and a second EI combination hypothesis, and wherein the second EI combination hypothesis is initiated while the first EI combination hypothesis is running.

14. The electronic device of claim 8, wherein the plurality of available satellite signal carriers are combined into the number of signal combinations based on maximum combining ratio (MCR) weights.

15. The electronic device of claim 8, further comprising a battery, and wherein the hypothesis are generated based on a remaining battery life of the battery.

16. A method for determining a location of a device in a global navigation satellite system (GNSS), comprising:
selecting a first device location determining process based on a power consumption of the first device location determining process on the device;
attempting to locate the device with the selected first device location determining process; and
selecting a second device determining location process when the attempting with the first device location determining process fails;
wherein the second device location determining process has a higher power consumption than the power consumption of the first device location determining process.

17. The method of claim 16, further comprising:
attempting to locate the device with the second device location determining process; and
selecting a third device location determining process when the attempting with the second device location determining process fails,
wherein the third device location determining process has a higher power consumption than the power consumption of the second device location determining process.

18. The method of claim 16, wherein the device location determining processes are selected from a predetermined list of processes hierarchically ordered based on a required power consumption of each process.

19. The method of claim 18, wherein the selected first device location determining process requires the least amount of power consumption of the processes included in the predetermined list.

20. The method of claim 16, wherein the first device location determining process is selected based on a remaining battery life of the device.
